(19) United States
(12) Patent Application Publication
(10) Pub. No.: US 2005/0252966 A1
(43) Pub. Date: Nov. 17, 2005

(54) Purchasing system using object matching

(76) Inventor: Chares J. Kulas, San Francisco, CA (US)

Correspondence Address: CHARLES J. KULAS, 651 ORIZABA AVE., SAN FRANCISCO, CA, 94132, US

(21) Appl. No.: 11/122,305

(22) Filed: May 3, 2005

Related U.S. Application Data
(60) Provisional application No. 60/570,526, filed on May 12, 2004.

(51) Int. Cl. G06K 15/00; G06F 17/60

(52) U.S. Cl. 235/383; 705/27

(57) ABSTRACT

Embodiments of the invention allow a consumer to make an online purchase of an encountered item. In one embodiment the encountered item to be purchased is photographed by a camera in, e.g., a cell phone. The image is sent via the cellular phone network to the Internet where it is received by a commerce center. The commerce center includes automated and manual image-matching tools. If the image is matched (i.e., identified with a predetermined degree of confidence) a message is sent back to the consumer's cell phone to indicate the cost to purchase the image from the commerce center or from another source. The consumer indicates whether and how many of the item type to purchase. Assuming the consumer has registered with the commerce center to provide transaction information such as a name, credit card number, shipping address, etc., the commerce center completes the transaction. Transaction options are available, such as allowing the consumer to request more information to be sent to the consumer's personal computer email address, have hardcopy information mailed, allowing the consumer to specify the item delivered to another party, selecting the item as a gift, obtaining information on related items, etc.

### CLAIM OF PRIORITY

This application claims priority from U.S. Provisional Patent Application Ser. No. 60/570,526 entitled “PURCHASING SYSTEM USING OBJECT MATCHING” filed on May 12, 2004, which is hereby incorporated by reference as if set forth in full in this application for all purposes.

### BACKGROUND OF THE INVENTION

Internet purchasing, or “ecommerce,” is a fast-growing market. Consumers can realize time and cost savings by purchasing online and not having to go to a point-of-sale store to make a transaction. However, one problem with ecommerce purchases is that the consumer is not able to examine firsthand the product they are buying. While this may not be a drawback for commodity purchases such as books, electronic devices, pens, etc., it can be inappropriate for more unique, individual or personal items such as clothes, perfumes, food, etc.

Another disadvantage to ecommerce is that it is not tied in to a consumer's everyday of-the-moment experiences. For example, if a consumer tastes a bottle of wine that they like they are not able to make a convenient electronic purchase of the wine. If a consumer tries on a piece of clothing they typically have to write down the brand and size of the apparel in order to make an online purchase at a later time. Often, the act of obtaining enough information to identify the item to purchase online, and the separation in time and space of the event of desiring to make a purchase and performing the actual act of the purchase is enough to cause the consumer to not follow through with the purchase.

### SUMMARY OF THE INVENTION

Embodiments of the invention allow a consumer to make an online purchase of an encountered item. In one embodiment the encountered item to be purchased is photographed by a camera in, e.g., a cell phone. The image is sent via the cellular phone network to the Internet where it is received by a commerce center. The commerce center includes automated and manual image-matching tools. If the image is matched (i.e., identified with a predetermined degree of confidence) a message is sent back to the consumer's cell phone to indicate the cost to purchase the image from the commerce center or from another source.

The consumer indicates whether and how many of the item type to purchase. Assuming the consumer has registered with the commerce center to provide transaction information such as a name, credit card number, shipping address, etc., the commerce center completes the transaction. Transaction options are available, such as allowing the consumer to request more information to be sent to the consumer's personal computer email address, have hardcopy information mailed, allowing the consumer to specify that the item be delivered to another party, selecting the item as a gift, obtaining information on related items, etc.

Another embodiment of the invention provides for detection or identification of an item of interest other than by image. The item can be provided with a bar code or other positive identification that can be photographed, scanned or captured by other means. A radio-frequency identification (RFID) tag can be sensed with a portable sensing device that is in communication with a network so that the information can be sent to the commerce center. Other variations are possible.

In one embodiment the invention provides a system for purchasing an item, the system comprising a processor for receiving an image of the item from a user device; a database including a plurality of item images; a matching process for matching the item with one of the plurality of item images; and a transaction process for sending transaction information to the user device.

In another embodiment the invention provides a system for purchasing an item, the system comprising a processor for receiving identification information of the item from a user device; a database including a plurality of item images; a matching process for matching the identification information with one of a plurality of identification information; and a transaction process for sending transaction information to the user device in response to a matching of identification information of the item with one of a plurality of identification information.

in another embodiment the invention provides a method for purchasing an item, the method comprising receiving identification information of the item from a user device; storing a plurality of identification information in a database; matching the identification information with one of a plurality of identification information; and

sending transaction information to the user device in response to a matching of identification information of the item with one of a plurality of identification information.

In another embodiment the invention provides a machine-readable medium including instructions executable by a processor for purchasing an item, the medium comprising one or more instructions for receiving identification information of the item from a user device; one or more instructions for storing a plurality of idenin a database; one or more instructions for matching the identification information with one of a plurality of identification information; and one or more instructions for sending transaction information to the user device in response to a matching of identification information of the item with one of a plurality of identification information.

In another embodiment the invention provides an apparatus for purchasing an item, the apparatus comprising means for receiving identification information of the item from a user device; means for storing a plurality of idenin a database; means for matching the identification information with one of a plurality of identification information; and means for sending transaction information to the user device in response to a matching of identification information of the item with one of a plurality of identification information.

### BRIEF DESCRIPTION OF THE DRAWINGS

FIG. 1 illustrates basic components of the present invention.

### DETAILED DESCRIPTION OF THE INVENTION

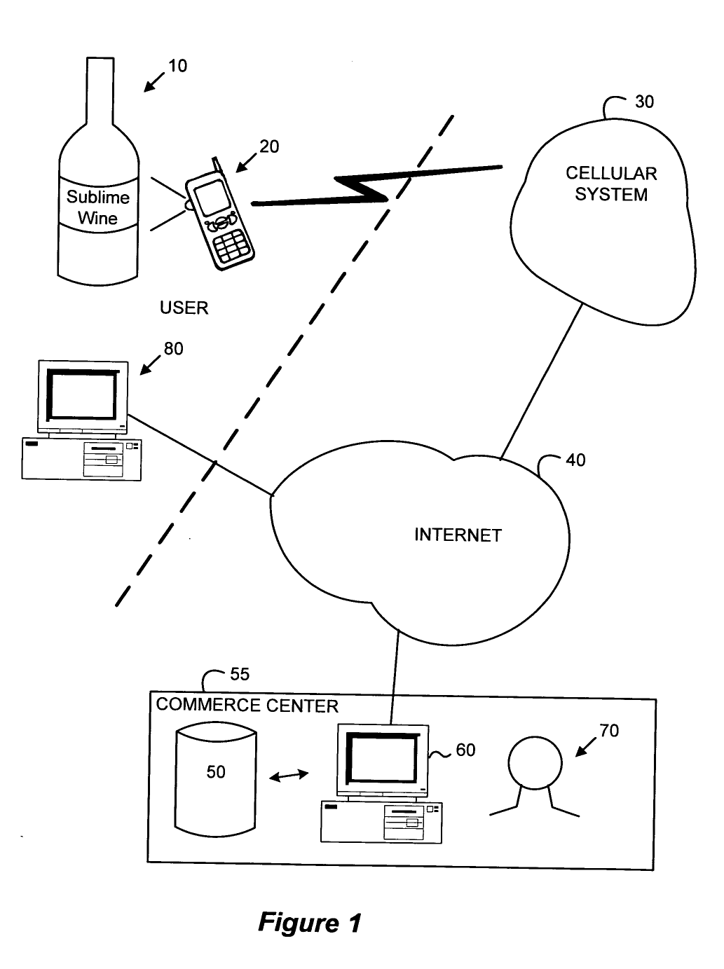

FIG. 1 shows consumer or user cell phone 20 with a camera used to take a picture of item 10 (in this case a wine bottle label). The image is conveyed via cellular system 30 to Internet 40. Although specific devices, communication means and other specifics may be presented herein, it should be apparent that other variations may be employed. For example, any type of device to capture or indicate item characteristics can be used. Also, any communication means to convey information from the device to a destination can be used. In a preferred embodiment, the user takes a picture and can depress a single key (e.g., the #, or ‘pound’ key) to start a process to send the image to a commerce center for purchase.

Commerce center 55 includes database 50, computer 60 and operator 70. In general, any type of manual or automatic functionality can be included in a commerce center. The operations of the commerce center need not occur at a single location or at a same time. Operations, or functions, can be performed by multiple processors, stations, centers, or the like. Processing can be in real time, offline, in batch mode, etc. Any type of processing (e.g., combination of hardware and software) can be used to implement the functionality described herein. Commerce center 55 can be a business location, individual, automated process or any other structure to achieve the functionality of facilitating a user's purchase of the item.

In a preferred embodiment, computer 60 is used to check database 50 in order to match, or identify, the image sent from cell phone 20. Additionally, operator 70 can participate in visually matching the item image with known images in a database. Other approaches can be employed to perform matching and identification.

If identified with a predetermined degree of confidence, the identification is conveyed to the user at the user device (e.g., cell phone). The user is also presented with the purchase price if the identified item is to be obtained from the commerce center. Any other type of purchase option can be provided. For example, the user can be provided with an option to see other variations of the same product. The user can select, e.g., by pressing numeric buttons on the cell phone keypad, a desired quantity. Price can vary with quantity. Delivery options can be specified, etc.

One embodiment sends an email message either to the user's cell phone or to the user's computer, as specified in a user profile that is obtained from the user at an earlier time. Sending an email to the user's computer has advantages in that more information (e.g., pictures, hyperlinks, text) can be provided since a personal computer typically has more resources than a cell phone. The manner in which a transaction is achieved can be selected by the user at a prior time as, for example, at a website operated by the commerce center or by another entity. The user can also set up a user profile that includes basic transaction information such as the user's name, credit card number, expiration date, address for delivery, manner of delivery, etc.

Assuming the user selects to purchase the item or items in the manner described by the commerce center in a text message to the user's cell phone (or by other means) the commerce center takes action to complete the user's purchase (e.g., charging the user's credit card) and initiates shipment of the item to the user. Note that any feasible method of sending the item (or similar item) to the user can be used with the present invention. For example, if the item is software, audio, image or other digital media, the item can be automatically downloaded to the user's computer, cell phone, or other pre-designated device of the user's choice.

Any type of image matching or object identification technology can be used. In a preferred embodiment, image database software such as PhotoMechanic from www.camerabits.com, ThumbsPlus from www.cerious.com, etc. can be used with a human operator to assist in identification of an object from an image. Any suitable approach to identifying an item, including the use of future technologies, can be used with features of the present invention.

Although embodiments of the invention have been described primarily with respect to a cell phone, any type of communication device (e.g., computer, personal digital assistant, pager, wireless email access device, radio transmitter, etc.) can benefit from features of the invention. Other devices such as audio players, recording devices, computers, etc., can similarly benefit from features of the invention, especially where a camera, bar code reader, RFID detector or other detection means is built into the device.

Any suitable programming language can be used to implement the routines of the present invention including C, C++, Java, assembly language, etc. Different programming techniques can be employed such as procedural or object oriented. The routines can execute on a single processing device or multiple processors. Although the steps, operations or computations may be presented in a specific order, this order may be changed in different embodiments. In some embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. Distributed, or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

Thus, the scope of the invention is to be determined solely by the appended claims.

1. A method for purchasing an item, the method comprising:
receiving a digital photograph of the item from a user device;
accessing a database, wherein the database includes a plurality of item images;
matching the digital photograph of the item with one of the plurality of item images; and
sending transaction information to the user device for purchase of the item.

2. The method of claim 1, wherein matching includes using input from a human operator.

3. The method of claim 1, wherein matching includes using automated image software.

4. The method of claim 1, further comprising:
sending a price for the item to the user device.

5. The method of claim 1, further comprising:
sending descriptive information about the item to the user device.

6. The method of claim 1, further comprising:
accepting a signal from the user device to designate a shipping address for the item.

7. The method of claim 1, wherein the user device is a cell phone, the method further comprising:
accepting a signal generated by a numeric keypad on the cell phone to indicate a number of the items to be purchased.

8. The method of claim 1, wherein the user device is a cell phone, the method further comprising:
sending an email message to the cell phone, wherein the email message includes information about the item.

9. The method of claim 1, further comprising:
sending an email message about the item to a computer associated with the user.

10. An apparatus for purchasing an item, the apparatus comprising:
a processor;
a machine-readable medium including instructions executable by the processor for receiving a digital photograph of the item from a user device;
accessing a database, wherein the database includes a plurality of item images;
matching the digital photograph of the item with one of the plurality of item images; and
sending transaction information to the user device for purchase of the item.

11. A machine-readable medium including instructions executable by a processor, wherein the machine-readable medium includes:
one or more instructions for receiving a digital photograph of the item from a user device;
one or more instructions for accessing a database, wherein the database includes a plurality of item images;
one or more instructions for matching the digital photograph of the item with one of the plurality of item images; and
one or more instructions for sending transaction information to the user device for purchase of the item.
